(19) United States
(12) Patent Application Publication
(10) Pub. No.: US 2012/0016274 A1
(43) Pub. Date: Jan. 19, 2012

(54) Systems and Methods for Providing Multiple Therapies to a Reclined Human Subject

(76) Inventor: Todd Howe, Fort Collins, CO (US)

(21) Appl. No.: 13/185,614

(22) Filed: Jul. 19, 2011

Related U.S. Application Data
(60) Provisional application No. 61/365,458, filed on Jul. 19, 2010.
(60) Provisional application No. 61/368,634, filed on Jul. 28, 2010.

(51) Int. Cl. A61H 9/00

(52) U.S. Cl. 601/15; 601/148

(57) ABSTRACT

Systems and methods for providing dry hydrotherapy, augmented by thermal, visual, olfactory, and auditory sources and sinks, to a reclined human subject. A dry hydrotherapy bed includes a canopy which programmatically emits light in varying frequencies, amplitudes, and durations. Other embodiments control the temperature of the pressurized liquid, and the aromas and sounds presented to the user. A variable speed pump motor control and a twin gear drive system improve control of hydrotherapy forces. A separate, liquid filled barrier on the top surface of the bed reduces the noise created from the pressurized liquid discharge. A combined cover and sheet system uses a loose fitting sheet over the massage window with a cover for a flat top surface. An electrical grounding means discharges any accumulated electricity from the user's body. The invention can be embodied in a stand-alone unit or adapted to an existing home or commercial building.

### RELATED PATENT

This application incorporates by reference U.S. Pat. No. 7,311,683 in its entirety. This application claims the benefit of the filing date of U.S. Provisional Application Ser. No. 61/365,458, filed on Jul. 19, 2011, entitled “Systems and Methods for Providing Multiple Therapies to a Reclined Human Subject” and U.S. Provisional Application Ser. No. 61/368,634, filed on Jul. 29, 2011, entitled “Systems and Methods for Providing Multiple therapies to a Reclined Human Subject”, the entire disclosure of which is hereby incorporated by reference.

### FIELD OF THE INVENTION

The present invention relates to dry hydrotherapy systems and methods, and specifically to stimulating circulation and lymphatic flow and for supporting, massaging, relaxing, and soothing the body of a reclined human subject.

### BACKGROUND

A person may receive massage therapy by lying horizontally on a flexible membrane, suspended by a bed-like structure, which membrane has a pressurized liquid directed at its underside. The liquid impinging on the underside of the flexible membrane transfers its kinetic energy to the person lying on the membrane so that the person experiences massage-like forces without getting wet. Dry hydrotherapy devices, such as beds, are known in the art and are available commercially. However, these devices still lack many useful features and suffer from multiple inefficiencies, limitations, and constraints.

### BRIEF SUMMARY OF THE INVENTION

A principal object of the present invention is to provide dry hydrotherapy systems and methods that are better than the prior art despite all the nay-sayers, challenges, supposed impossibilities and discouragement known in the art. One aspect of this is to minimize bulk, cost and complexity while increasing user-friendliness and durability and while uniting experiences and improvements such that the resulting benefit is significantly greater than the sum of its parts. Another object is to combine benefits and therapies in a single system to save time, cost and frustration for operators and users.

To those ends, among others, the present invention includes systems and methods for providing an aesthetically appealing user support that optimizes conditions for the user while providing dry hydrotherapy, augmented by thermal, visual, olfactory, and auditory sources and sinks, to a reclined human subject in a home or commercial environment. Embodiments of the invention provide safe, comfortable and healthy support with optimal therapy, while enabling a user to control the temperature of the pressurized liquid to increase the effectiveness or sensation to the user. The liquid can also be heated to further stimulate circulation, or cooled or maintained at a neutral temperature according to the user's preference. Further, preferred embodiments include features for facial rejuvenation, and include means to present aromas and relaxing sounds to a user, with or without accompanying light or massage therapies.

An electrical grounding means also discharges any accumulated electricity stored or generated in the user's body during the therapy, for additional therapeutic benefits. To enable better user control of massage forces, preferred embodiments of the present invention include a variable speed pump motor control system that enables the user to make small or large changes in the pressurized liquid flow. A twin gear drive system improves the user's ability to precisely control the position of the pressurized liquid discharge so that the user can apply the liquid forces at different points on their body and change the position of the discharge more rapidly than previously possible.

Other objects of the invention include the provision of optimal dry hydrotherapy that is more amenable to users in a wide variety of settings. Such objects are achieved in part by providing dry hydrotherapy while minimizing the typical noise produced by such therapies known in the art. Some embodiments achieve this in part with a separate, liquid filled barrier permanently affixed to the top surface of the membrane to substantially reduce the noise created from the pressurized liquid discharge striking the underside of the membrane. Even more benefit is provided by features that minimize or eliminate the liquid-filled barrier where the user is lying, and maximize it where the person is not lying. Preferably, a combined cover and sheet system uses an extra-thin, loose-fitting sheet over a central massage window to deliver more vigorous hydrotherapy reduce kinetic energy losses in this window while the cover, as a whole, retains a generally flat top surface despite the hydrotherapy forces.

The disclosure, including descriptions, drawings, and claims, describes one or more embodiments of the invention. Many other features, objects, and advantages of the invention will be apparent to one of ordinary skill in the art from the disclosure. Given the disclosure, especially in light of the prior art, it is another object of the invention to improve upon, and overcome the inefficiencies, limitations, and constraints of, the prior art.

### BRIEF DESCRIPTION OF THE DRAWINGS

U.S. Pat. No. 7,311,683 (the “Terell patent”) is incorporated by reference in its entirety into this application. FIGS. 2, 11, and 13 from the Turell Patent are reproduced herein for the convenience of the reader. Figures new to this application are marked with the prefix “A-” such as FIG. A-1, FIG. A-2, etc.

FIG. 2 is a perspective view of the dry hydrotherapy subassembly 20 of the preferred dry hydrotherapy sleep system 10.

FIG. 11 is an end view of the core tub component of the system of the preferred embodiment, with an end cover removed, showing the water pump, valve, and control systems.

FIG. 13 is a plan view of the controller component enclosure of the system of the preferred embodiment and the various electrical and electronic connections.

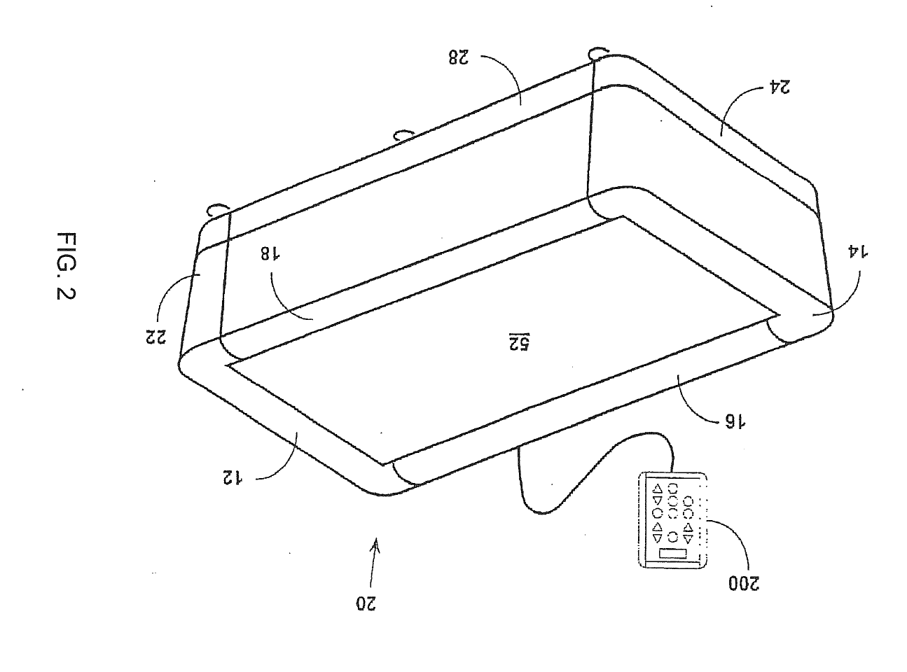

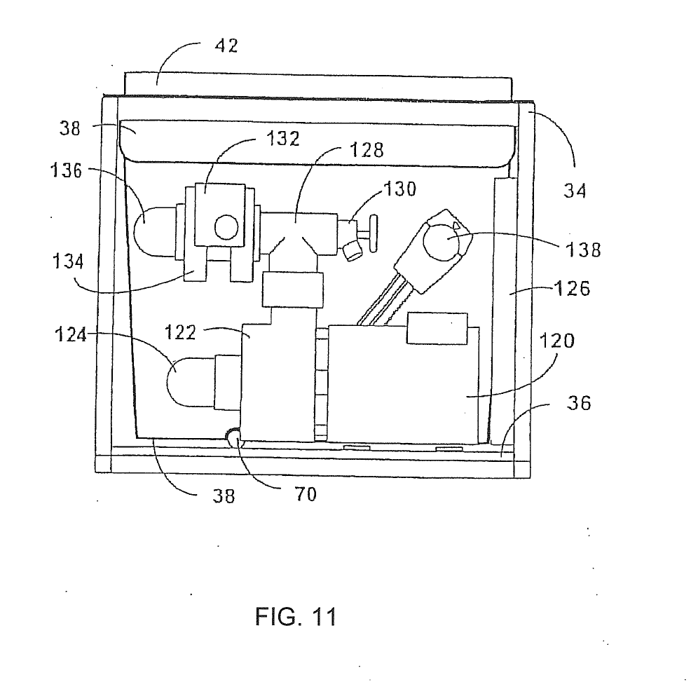

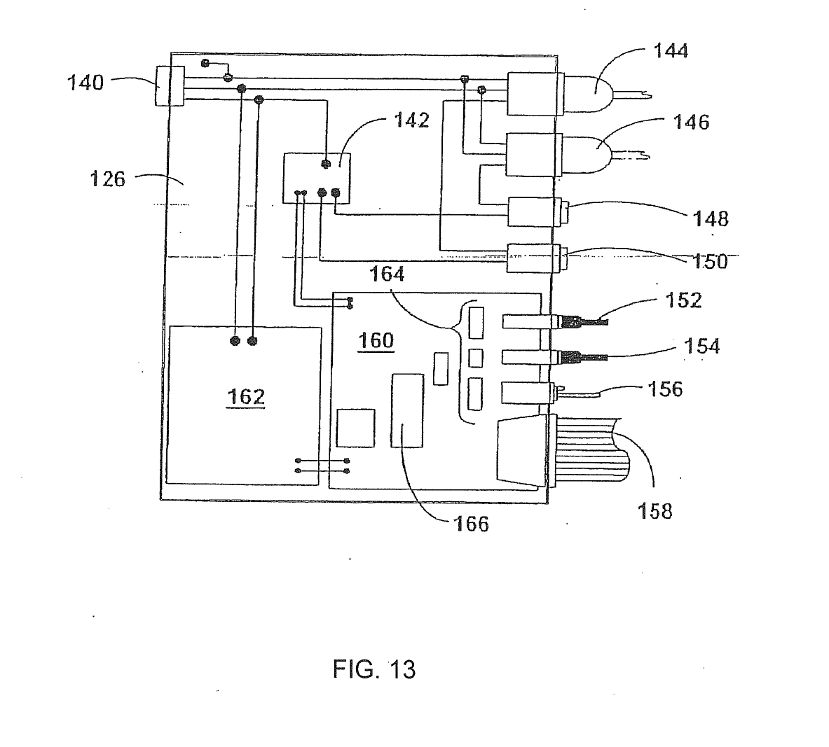

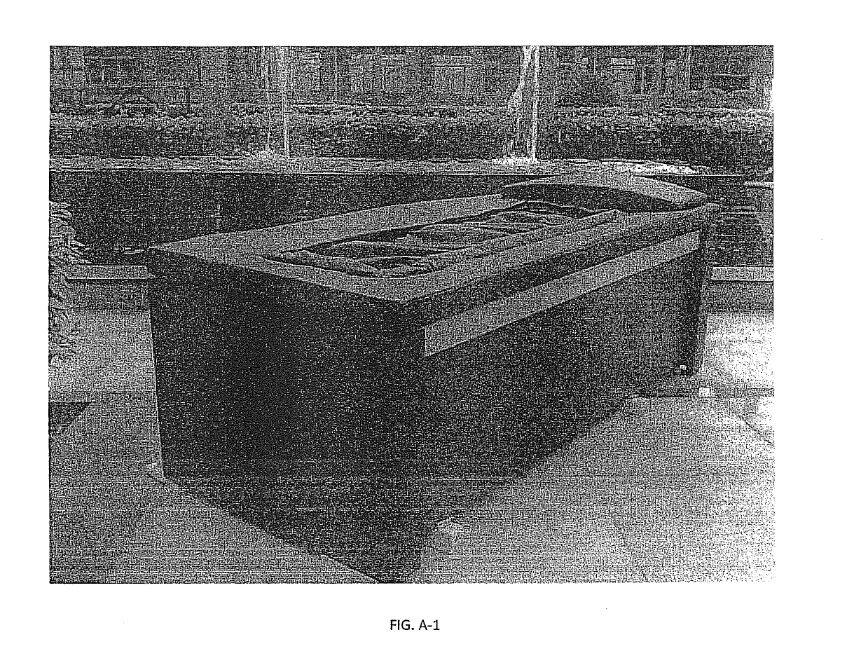

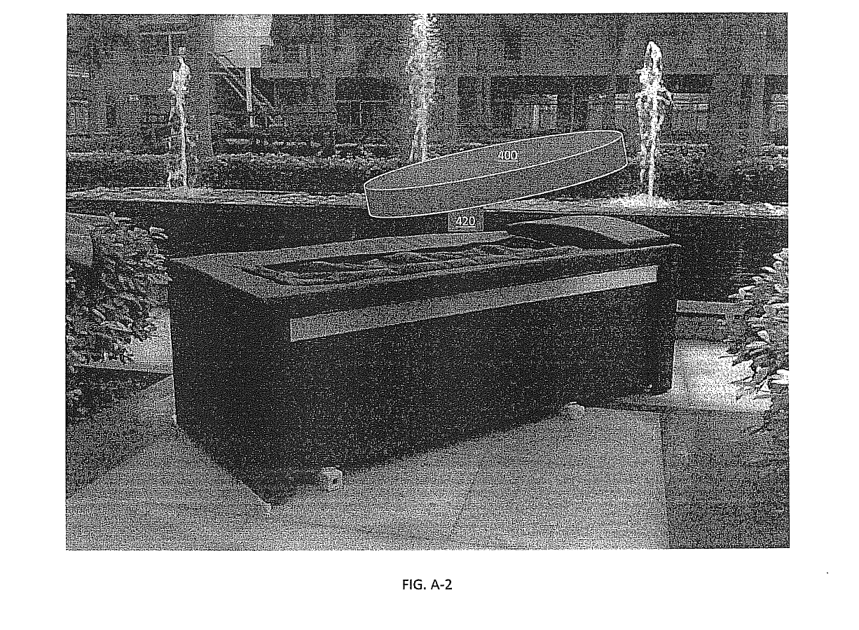

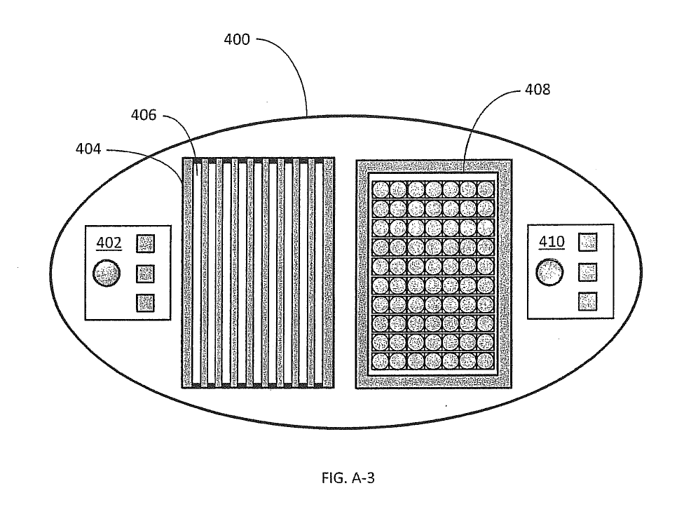

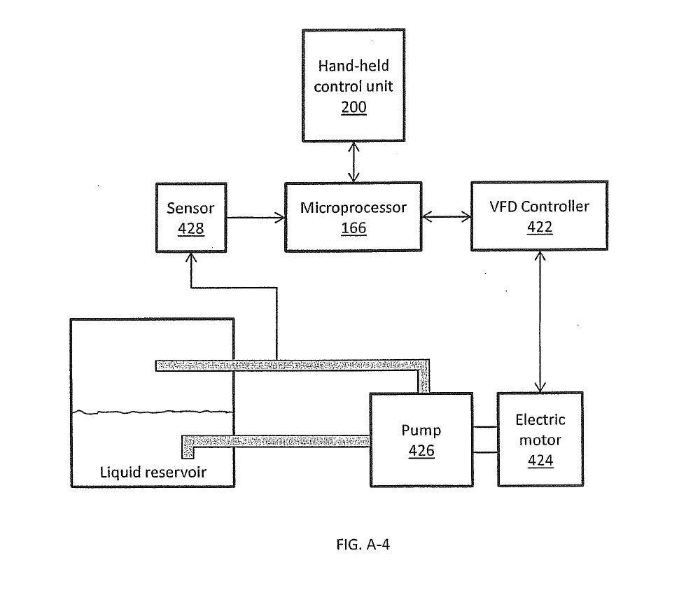

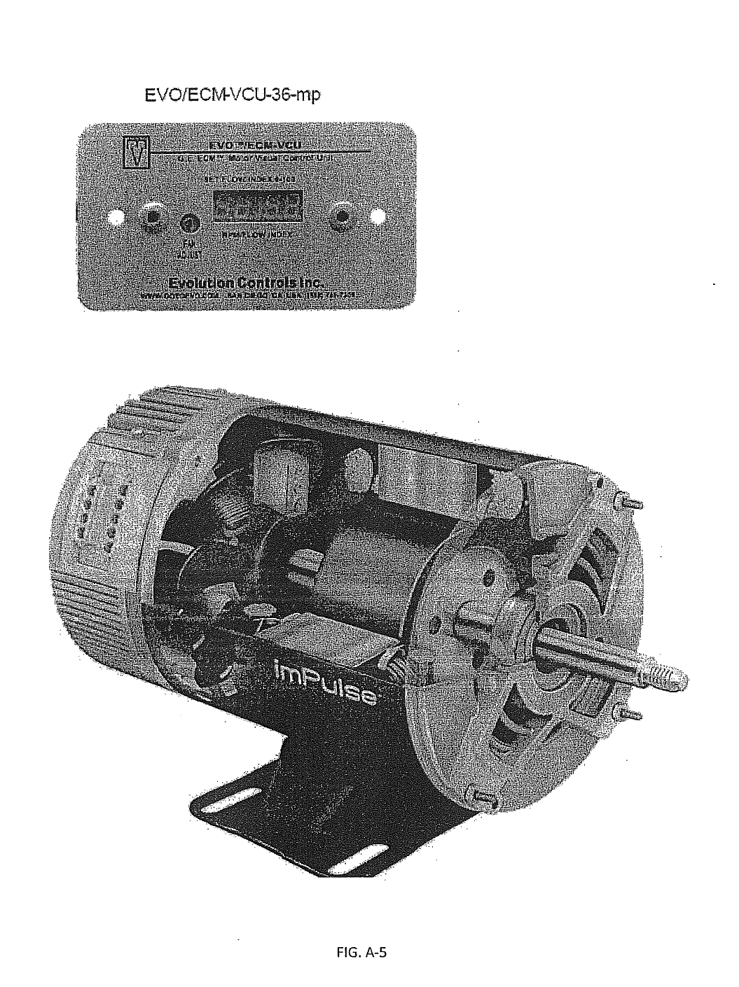

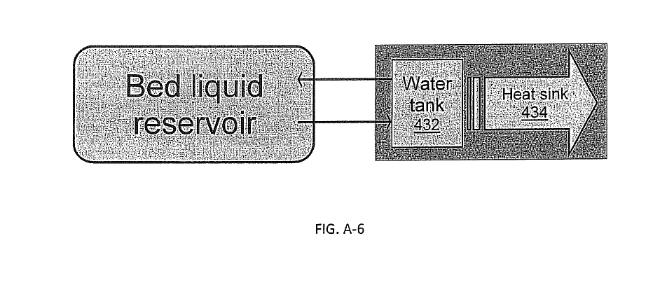

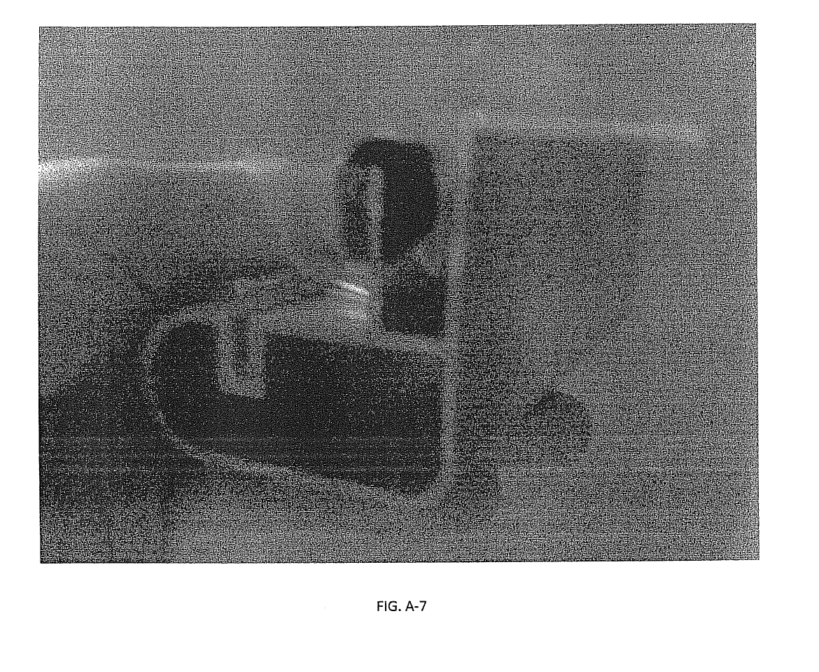

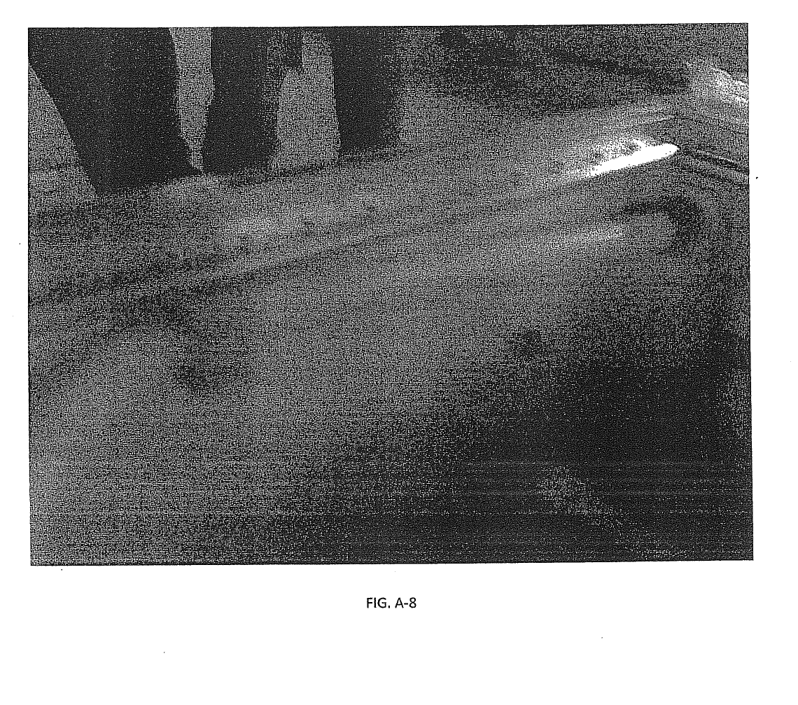

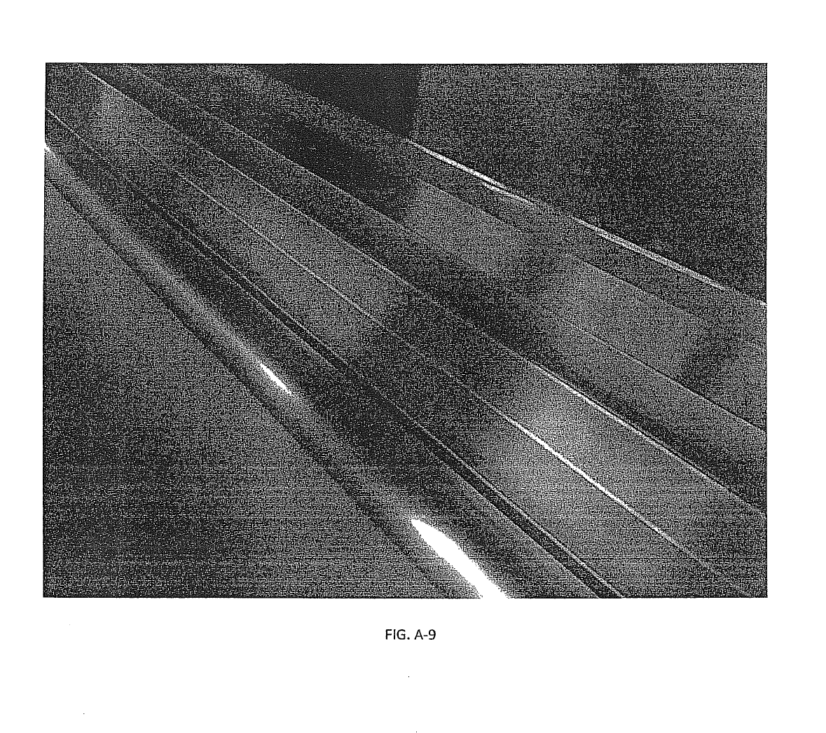

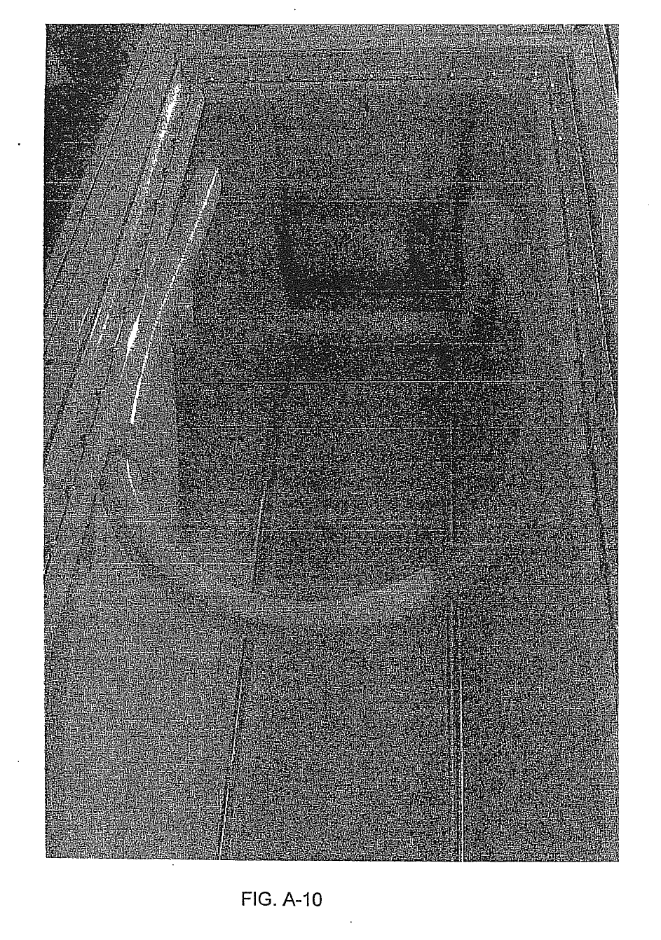

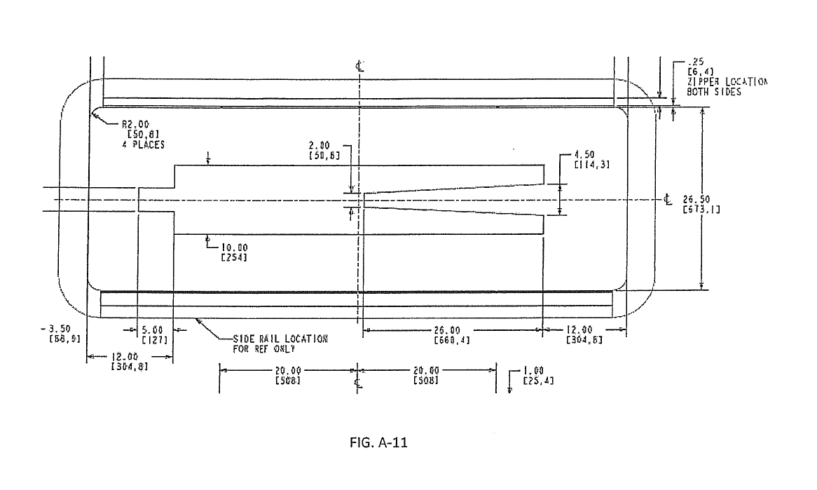

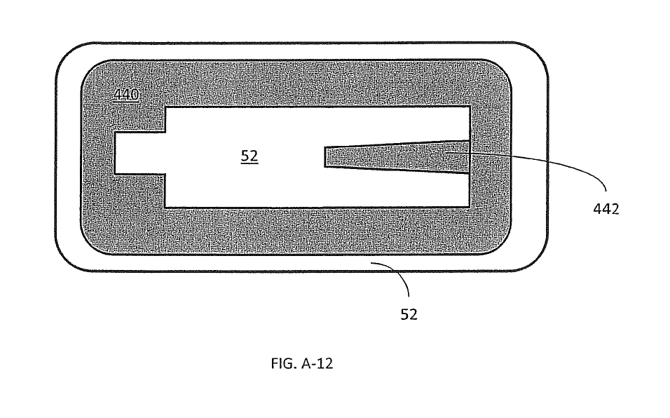

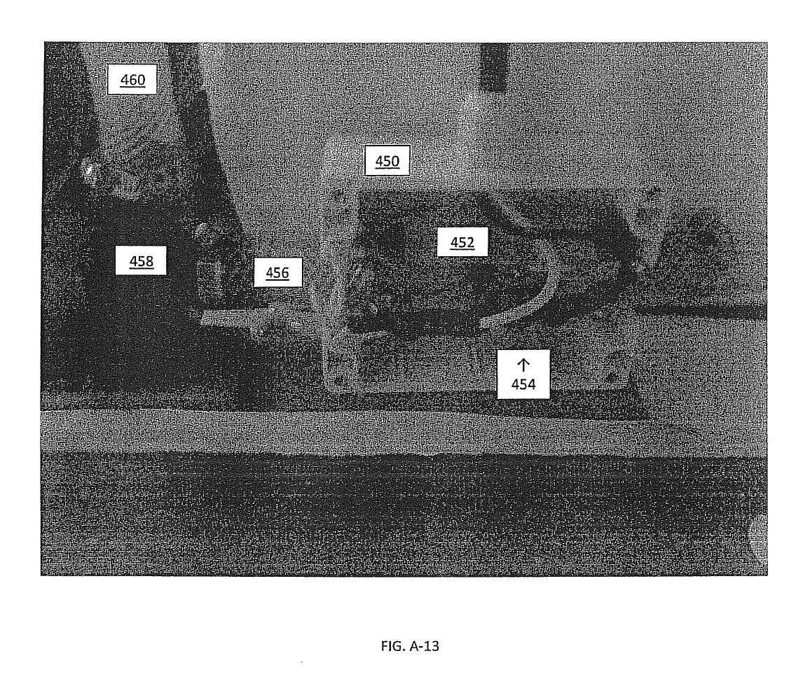

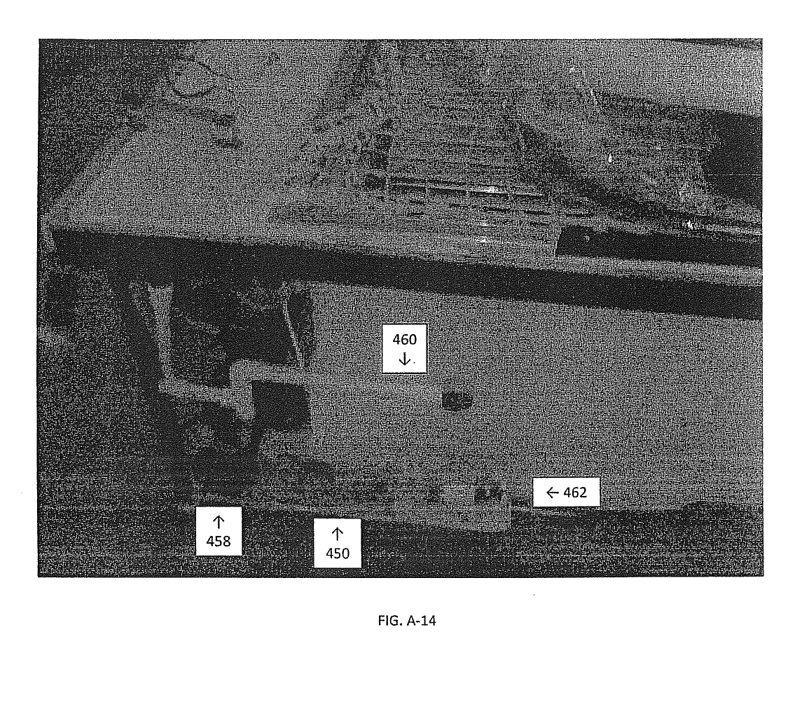

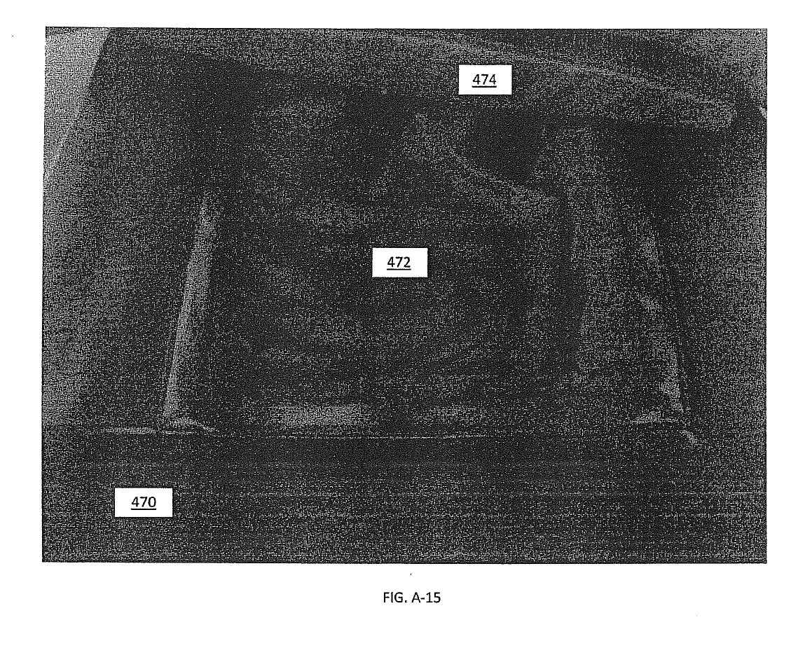

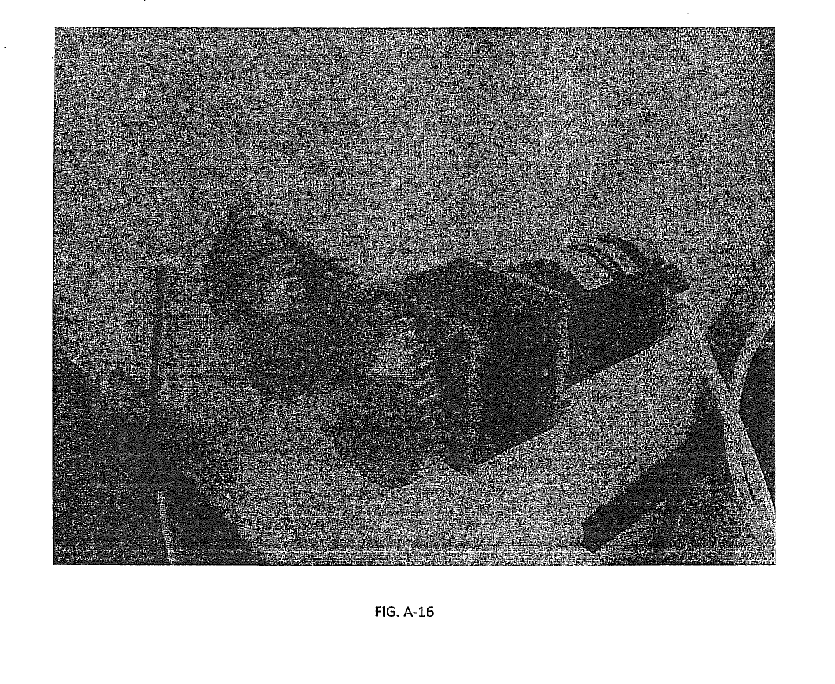

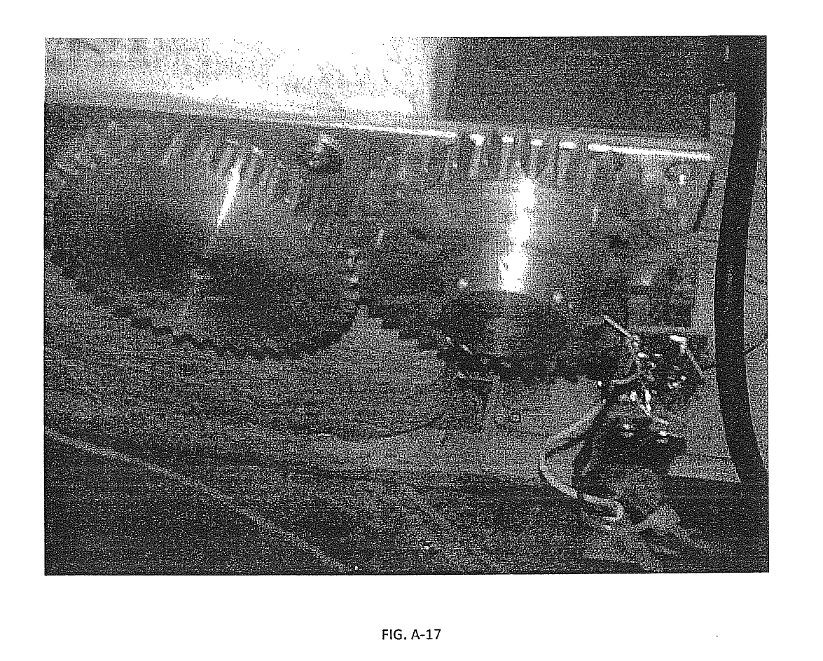

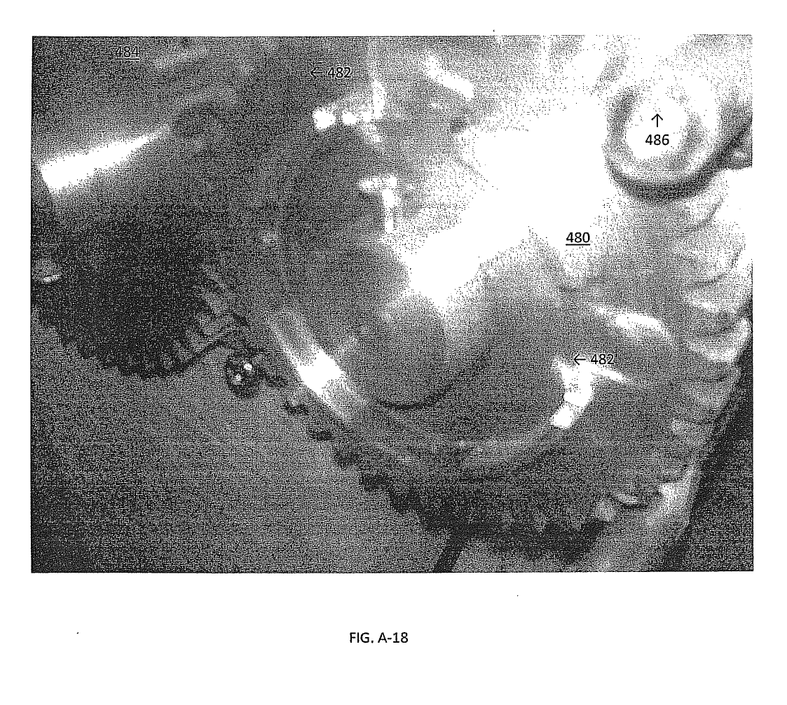

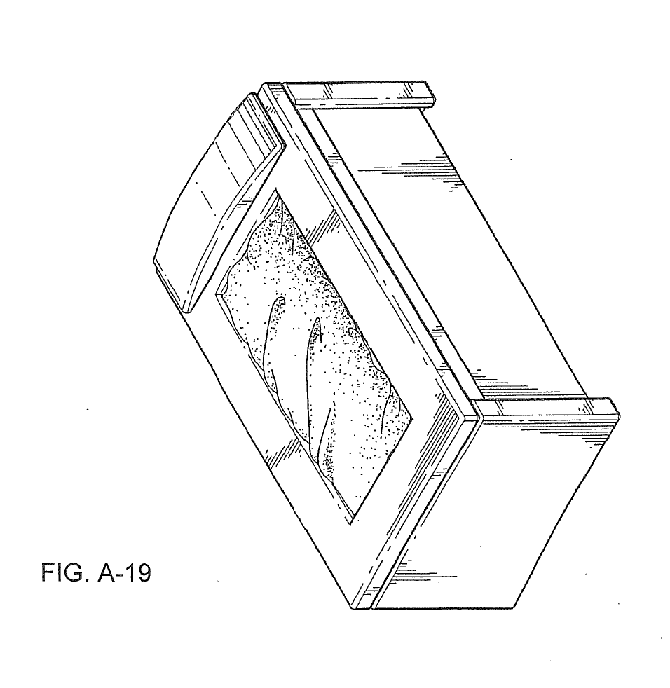

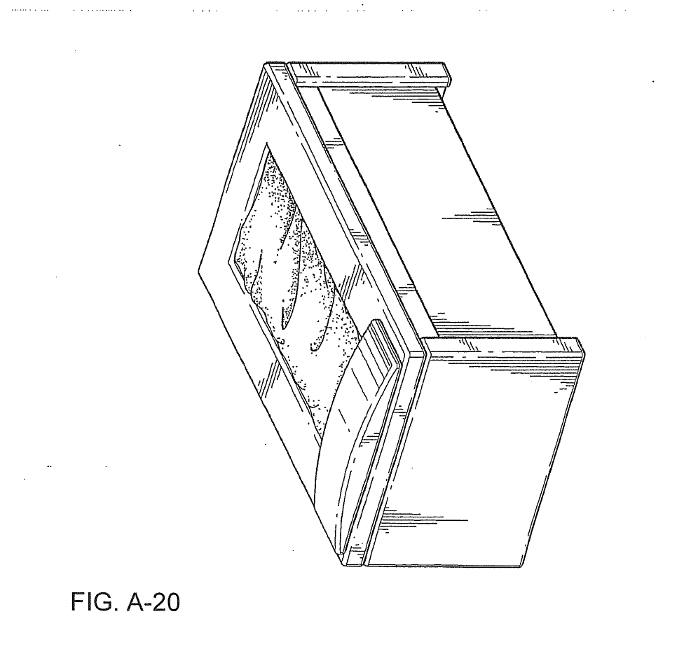

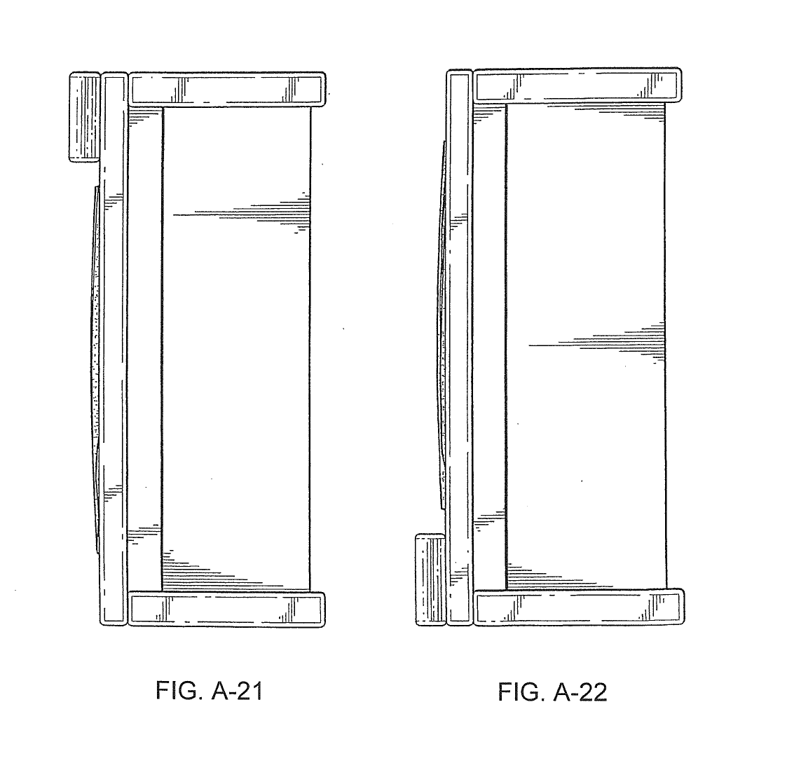

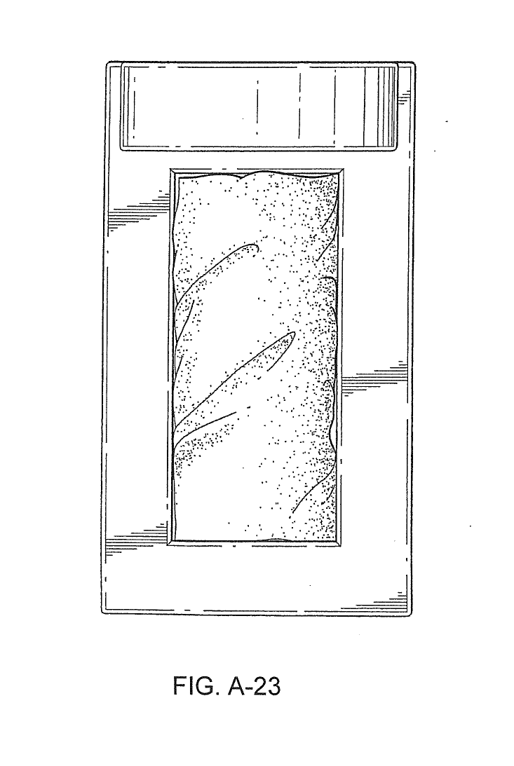

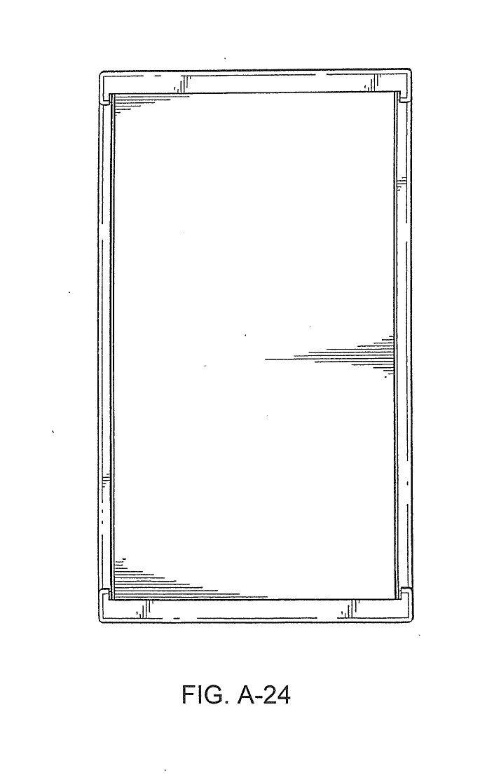

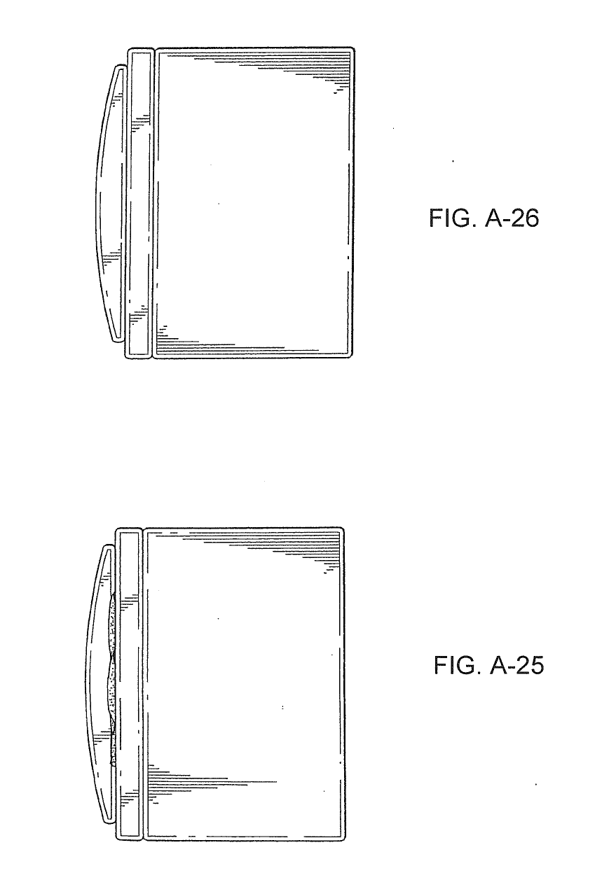

FIG. A-1 is a photograph of an embodiment of the dry hydrotherapy bed which also shows an example decorative end panel, side panel, pillow, and cover.

FIG. A-2 is an annotated photograph showing the placement of a canopy assembly to contain light emitting sources for use in light therapies such as for facial rejuvenation or light stimulation for seasonal affective disorder.

FIG. A-3 shows a view of an example therapy canopy 400 equipped with lights and controls for light therapies. The canopy is typically positioned over the user's head or upper body and directs light, sound, aromas, or other therapies towards the user.

FIG. A-4 is a block diagram of a variable speed pump system used to control the discharge pressure for the dry hydrotherapy system.

FIG. A-5 shows motor speed control units used to make a variable speed motor. A pump is mechanically coupled to a variable speed motor. The motor responds to signals from the electrical control box, and our proprietary software controls the motor controller. Thus we control the pump discharge pressure by controlling the motor's speed.

FIG. A-6 depicts a liquid cooling subsystem that is external to the bed assembly. The liquid cooling subsystem dissipates the liquid's thermal energy using a heat sink, and includes a reservoir for additional liquid.

FIG. A-7 shows a cross-section view photograph of one embodiment of a frame support that supports flexible membrane 52 and also dissipates waste heat from the pressurized liquid as the liquid impinges on the frame support. The frame support also ensures a water seal below the top surface edge of the liquid reservoir.

FIG. A-8 shows the frame support and the single pivot hose with a fixed clamp to the side of the frame.

FIG. A-9 shows an example embodiment of the frame support as an aluminum extruded form with a seal lip which is below the top of the frame and which form is attached to the top of the tub.

FIG. A-10 shows an example of an extruded aluminum frame support painted white. The metal screws used to secure flexible membrane 52 to the frame support are visible in the photograph and are shown extending upward from the groove or track into which they are secured.

FIG. A-11 is a drawing of the human body shaped sound barrier which, when filled to an appropriate level, extends upward from the top surface of the flexible membrane by a few inches and surrounds the user's periphery while the user is lying on the flexible membrane.

FIG. A-12 shows an overhead view of a dry hydrotherapy bed embodiment with primary inflatable bladder 440 and secondary inflatable bladder 442 affixed to the top surface of flexible membrane 52.

FIG. A-13 is a close up view photograph of the liquid heater assembly. A low pressure water pump suctions water from tub 38, draws it through a heating element (shown inside a rectangular container) and discharges the heated water into tub 38.

FIG. A-14 is a distant view photograph of the external heater with a small pump that draws water from tub 38, heats the water, and returns it to tub 38.

FIG. A-15 is a photograph of the top cover of the system showing the replaceable sheet which is attached into the massage window by a readily removable means (such as a hook and loop fastener).

FIG. A-16 is a photograph of a twin gear drive system mounted to the side of the tub.

FIG. A-17 is a photograph of an embodiment where a position encoder is affixed to a gear motor.

FIG. A-18 is a photograph of a dual gear drive mechanism with raised tabs needed to provide gear position information for a position encoder.

FIGS. A-19 through A-26 show an ornamental design of a preferred embodiment of the invention.

### DETAILED DESCRIPTION OF PREFERRED EMBODIMENTS

Preferred embodiments of the present invention involve improvements to the dry hydrotherapy sleep system 10 described and shown in the figures from U.S. Pat. No. 7,311,683 (the “Turell Patent”). With reference to the description and figures of the Turell Patent, dry hydrotherapy sleep system 10 (and its various alternative embodiments) is comprised primarily of a sleep system subassembly 30 mounted atop core hydrotherapy subassembly 20. Coupled together in its operative configuration, the two subassemblies provide a generally twin bed sized platform for supporting a single human user on the top surface thereof. A hydrotherapy user control unit 200 and a sleep system user control 230 are connected to the internal controllers of the system 10 in a manner described in more detail in the Turell Patent. Although the two hand-held control units 200 and 230 may be united into a single, unified hand-held control as in alternative described herein, there are two (and potentially three or more) hand-held control units 200 and 230. The user control unit 200 provides the user with the ability to control the operational characteristics of the hydrotherapy subassembly 20 while in use, and the sleep system control unit 230 provides the user with the ability to control the operational characteristics of the sleep system subassembly 30 while in use. Although understandable variations are made to that sleep system in order to achieve the various improvements of the present invention, the components of Turell's sleep system 10 otherwise comprise the dry hydrotherapy system 10 of the now preferred embodiments. Likewise, one of ordinary skill in the art can implement the improvements of the present invention using one of the dry hydrotherapy beds previously commercialized by Applicant Vescent, Inc. (or others) as the foundation on which the improvements of the present invention may be implemented by one of skill in the art.

Getting back to the improvements of the present invention, FIG. A-1 is a photograph of an embodiment of the dry hydrotherapy bed 10, functionally and structurally much like the Turell Patent's sleep system 10, but otherwise constructed according to teachings of the present invention. In the example illustrated, the hydrotherapy bed 10 includes preferred decorative and ornamental features that make the system well suited for home use. Specifically, the decorative mix of wood and metal treatments on the end panels and side panels, the apparent firmness and lie of the fabric covering surrounding the massage window frame, the loose fitting sheet on the massage window, and the sculpted pillow at the head of the bed make the system compatible with many home bedroom decors. The combination of many of these features also provides a stylistic ornamental design as also shown in FIGS. A-19 to A-26.

### Light Therapy Canopy

In the context of the overall system of dry hydrotherapy bed 10, FIG. A-2 shows an embodiment of a dry hydrotherapy bed 10 equipped with light therapy canopy 400 supported by canopy arm 420. The light therapy canopy subsystem includes canopy 400, canopy arm 420, therapeutic lights, power supply, and controller.

Canopy 400, when energized, is adapted to direct therapeutic light onto a user, typically where the user is reclined on flexible membrane 52. In one embodiment, shown in FIG. A-2, canopy 400 is attached to a fixed canopy arm 420 so that canopy 400 is over and near the user's head and upper body. A fixed canopy position serves a dedicated use where the type of light therapy for which canopy 400 is configured does not require moving or adjusting canopy 400's position with respect to the user. In other embodiments, canopy 400 is attached to an adjustable canopy arm 420 so that canopy 400's lights may be positioned for optimal effect depending on the user's preferences and the types of light therapies to be delivered. Further, canopy arm 420 may allow canopy 410 to be temporarily removed or retracted to allow the user easier access onto and off of the bed surface. Also, canopy arm 420 enables canopy 400 to be stowed to the side of the bed when not in use. Similarly, canopy arm 420 may allow the canopy, individually, or the canopy and arm assembly, to be detached altogether. In some embodiments, canopy 400 is attached to canopy arm 420 in such a manner as to allow a quick change to a canopy head with a different configuration.

FIG. A-3 shows the underside (i.e., the side facing the user) of a particular variation of canopy 400 that is configured to provide one or more types of therapeutic light to the same or different users. The canopy assembly is preferably fitted with multiple instances of the same light sources, or with differing light sources. For example, FIG. A-3 shows canopy 400 fitted with tubular bulbs 406 as well as a panel 408 of LED bulbs. In other embodiments, the light emitters may be incandescent, fluorescent, LED, or other sources depending on the types of therapies to be provided. For example, skin treatments for acne may require a combination of blue and red fluorescent bulbs whereas a bright daylight treatment for Seasonal Affective Disorder (SAD) may require a combination of white and blue LEDs. The light sources can include light in different frequencies including visible, infrared, and ultraviolet bands. If canopy 400 is fitted with fluorescent bulbs and sockets, the fluorescent bulbs 406 may be changed to provide a different type of therapy. Similarly, if canopy 400 is equipped to receive an LED panel 408, a different therapy may be provided by substituting an LED panel which emits light in different frequencies. The light emitters in canopy 400 can be powered by the same electrical source used to power the other bed subsystems, or may be powered by an alternate power source. Preferably, one of the two bulb banks 406, 408 is of the full-spectrum type commercialized through the American Environmental Products enterprise (or its affiliates) based in Boulder, Colo. (www.sunalite.com); whereas the other panel preferably provides light with more concentration in the infrared spectrum.

The light therapies are programmatically or manually controlled using a therapy controller such as hand-held user control unit 200 or a separate therapy controller. The therapy controller may be electrically connected to main control circuit board assembly 160 or may communicate wirelessly with assembly 160 in an embodiment that includes a wireless communication means. In an alternative embodiment, separate, dedicated controls for light emitters, such as control 402 and control 410, may be affixed to canopy 400 or the light emitter assembly itself. In yet other embodiments, one or more multi-function therapy controllers, also represented by controls 402 and 410, may be embedded in, attached to, or in communication with therapy control means located in canopy 400. While the variable aspects of controls 402 and 410 may be a simple loaded timer that discontinues power to the therapeutic lights after the dialed amount of time, the therapy controller in other embodiments selects the mode, intensity, duration, and effects of one or more therapies. The therapy controller allows the user to manually control individual therapies or select from pre-programmed therapy profiles that feature concurrent, sequential, or multi-modal therapies. The therapy controller enables users to store, select, recall, and execute pre-programmed therapy profiles. The therapy controller also includes multiple features that apply to a selected therapy or therapies including one or more countdown timers, count-up timers, periodic cycle functions, and random variation functions.

The light therapies that can be applied using canopy 400, its light emitters, and therapy controller can be used alone, but in a preferred embodiment, light therapy is augmented with aroma therapy, acoustic therapy, electrical grounding therapy, and dry hydrotherapy. Canopy 400 can be configured with light emitters, and may also be configured with aroma and acoustic sources as well. These sources are also controlled by a therapy controller.

### Variable Speed Pump to Control Discharge Pressure

The present invention overcomes some of the limitations of the prior art systems by incorporating a variable speed pump to control the discharge pressure and thus vary the massage forces the user receives. FIG. A-4 shows a block diagram representing the components of the pump system. The components include proprietary software (not shown), hand-held control unit 200, microprocessor 166, Variable Frequency Drive (VFD) controller 422, electric motor 424 mechanically coupled to pump 426, discharge sensor 428, and the bed's liquid reservoir.

To vary the dry hydrotherapy massage forces, the user can manually set—or select a therapy profile that automatically controls—the pump discharge pressure. The user selects the desired pressure—or therapy profile—on hand-held control unit 200 which communicates with microprocessor 166. Proprietary software executing on microprocessor 166 communicates with VFD controller 422 to control the discharge pressure. The proprietary software includes logic that allows the user to manually adjust the massage forces, or select a therapy profile. A therapy profile is a stored combination of information used to achieve a series of desired therapies including dry hydrotherapy pressures, carriage locations, and durations. For example, a user may wish to have low pressure on their neck for two minutes, moderate pressure on their shoulders for six minutes, high pressure on their lower back for fifteen minutes, and conclude with a minimum pressure on their neck for five minutes. The proprietary software controls the massage forces—the pump discharge pressure—by sending commands to VFD controller 422.

VFD controller 422 governs the motor speed by varying the frequency of the power supplied to the electric motor. Generally, the higher the frequency of the power, the higher the motor speed. As part of its functionality, VFD controller 422 sends motor condition information to, and receives commands from, proprietary software executing on microprocessor 166. VFD controller 422 receives information from the motor including motor RPM and other monitored conditions. In turn, VFD controller 422 forwards that information to the proprietary software. The proprietary software determines a motor RPM that corresponds to the selected discharge pressure and sends appropriate command information to VFD controller 422. VFP controller 422 varies the frequency to achieve the desired motor RPM, and the pump produces a discharge pressure.

Sensor 428 completes a feedback loop by sending the actual pump discharge pressure to the proprietary software. The proprietary software compares the selected discharge pressure with the actual discharge pressure and sends correcting commands to VFD controller 422 as needed to match the actual discharge pressure to the selected discharge pressure. In a preferred embodiment, sensor 428 can act as a safety feature to prevent pump or motor damage. For example, if the liquid reservoir is unintentionally emptied while the pump is operating, sensor 428 reports pump discharge near zero which causes the proprietary software to command VFD controller 422 to shut down electric motor 424. In other embodiments, sensor 428 may be omitted where testing and experience shows a consistent relationship between electric motor 424 RPM and pump 426 discharge pressure and where the proprietary software or other systems provide appropriate safety shutoff controls.

VFD controller 422 may include various electronic devices to convert the single phase, 110 VAC power into the power needed to energize and control the motor. In a preferred embodiment, VFD controller 422 is an Evolution Controls, Inc. EVO/ECM-VCU, shown in FIG. A-5, and controls an electric motor capable of operating at varying speeds.

Electric motor 424 can be operated at variable speeds as it is controlled by the proprietary software and VFD controller 422. Electric motor 424 may be an alternating current (AC) single phase or three phase motor, or may be a brushless direct current (DC) motor. In a preferred embodiment, electric motor 424 is a General Electric ECM™ motor which is mechanically coupled to pump 426. Pump 426 is a pump suitable for generating sufficient fluid flow to meet the massage force requirements at operating pressures typically less than 30 pounds per square inch (psi). The present invention reduces the discharge pressure by slowing the speed of a variable speed pump. Other systems continuously operate the motor and pump at full speed and reduce the discharge pressure by restricting the effective size of a discharge orifice. The latter method consumes more energy, reduces pump life, and injects more waste heat into the liquid.

### Cooling Unit

FIG. A-6 is a block diagram of the cooling unit which dissipates waste heat from the liquid. Conventional systems for dissipating waste heat include commercial refrigeration units, typically with a cooling capacity on the order of 24,000 BTUs. Compared to the present invention, conventional systems are much more costly to purchase and maintain, and have a much higher energy usage. They require more space and generate much more noise than the present invention. Contrariwise, the present invention uses a system of heat sinks that require little or no power to operate, require comparably little space, and operate silently. As heat builds in the pressurized liquid, the liquid is circulated to water tank 432 which is in thermal communication with heat sink 434. The liquid is cooled by the heat sink fins. In a preferred embodiment, the heat sink fins are made of aluminum and attached to an external water tank 432 located apart from the bed. In other embodiments that require greater heat dissipation, a low pressure pump circulates heated liquid through radiator-like cooling fins that are themselves cooled by an electric fan. For embodiments that require less waste heat dissipation, water tank 432 may be omitted and heat sink 434 may be included inside space 40. The waste heat may be dissipated by natural convection alone, or may be augmented by a cooling fan moving air across the heat sink and discharging the heated air outside of space 40. If water tank 432 is used, it also acts as an additional liquid reservoir, which can reduce by three-fourths the need to refill the primary liquid reservoir.

More waste heat may be dissipated by the metal frame support shown in FIGS. A-7, A-8, A-9, and A-10. FIG. A-7 shows a cross section of one embodiment which uses an extruded aluminum frame support around the upper perimeter of the tub enclosure. The frame provides structural support for the bed assembly and is used to attach and secure flexible membrane 52. As the pressurized liquid impinges on the metal frame support, the liquid transfers some of its thermal energy to the frame support which conducts the waste heat into the ambient atmosphere. FIG. A-10 shows an example of an extruded aluminum frame support painted white and with the screws in place that are used to secure flexible membrane 52.

### Sound Barrier

Dry hydrotherapy subjects often complain that unwanted noise detracts from their massage experience. When the pressurized liquid impinges at a spot on flexible membrane 52 upon which the subject is not lying, membrane 52 vibrates—acting like an acoustic drum—and creates loud, unwanted noise. The noise is particularly problematic when the pressurized liquid is impinging on flexible membrane 52 near the subject's head. Conventional methods to reduce the unwanted noise include using a foam pad overlying the membrane. But the pad presents numerous problems. The pad may have gaps where the pad is not in contact with the membrane, which reduces the pad's noise cancelling effectiveness. Further the pad may have relatively stiff sides, which can cause the subject some discomfort if the pad is not fit precisely to the specific subject. Further, the pad does not automatically adapt to the subject's dimensions, which results in the two previous problems: lack of complete coverage, and subject discomfort where the subject's body abuts or overlaps the pad.

FIG. A-11 helps show how the present invention greatly reduces the unwanted noise while overcoming several limitations of conventional systems. The reduced noise enables the subject to hear ambient music, conversations, and other sounds. FIG. A-12 shows an overhead view of a dry hydrotherapy bed embodiment with primary inflatable bladder 440 and secondary inflatable bladder 442 affixed to the top surface of flexible membrane 52. Primary bladder 440 forms a sort of annulus surrounding the place where the subject lies. The annulus covers the plurality of the top of flexible membrane 52 with its outside perimeter in roughly rectangular shape and its inside perimeter resembling the shape of a human lying flat on his back. The annulus is created by placing a flexible plastic sheet on top of flexible membrane 52 where the plastic sheet forms the top boundary, and flexible membrane 52 forms the lower boundary. An air- and water-tight bladder annulus is formed by RF welding the plastic sheet to the top of flexible membrane 52. Primary bladder 440 is fitted with a fill tube to fill or empty primary bladder 440.

Secondary bladder 442 is a feature of some embodiments. It permits additional sound dampening by overlying flexible membrane 52 in the space between the subject's legs. The primary and secondary bladders are separate containers; there is no fluid communication between the two bladders. Like primary bladder 440, secondary bladder 442 is created by RF welding a plastic sheet on top of flexible membrane 52. Secondary bladder 442 is also fitted with a fill tube.

In FIG. A-12, the bladders are oriented so that the subject is positioned on flexible membrane 52 with the subject's head to the left and legs and feet extending to the right. The subject lies with the plurality of the subject's body directly on flexible membrane 52, or preferably on a loose fitting sheet on top of flexible membrane 52. Primary bladder 440 is filled with water but with sufficient air remaining in the bladder to allow the water to partially or completely displace away from the portions of the bladder on which the subject is lying. This automatic adaptation to the subject's form prevents the user's discomfort—from lying on a non-adaptive foam pad—while maximizing the amount of flexible membrane 52's surface covered by either the subject's body or sound-dampening water.

In some embodiments, the bladders are filled with water, preferably including an antimicrobial to minimize mold and mildew, but other embodiments may use a more viscous liquid such as a gel. The bladder liquids may also be temperature controlled for subject comfort. Preferably, the bladders are not filled to capacity but, rather, are filled to a fraction of their capacity in order to keep the top surface still relatively flat (although slightly convex). This partial filling allows the water within to be partially or completely squeezed out from under the user wherever the user's weight overlaps beyond the body-shaped place 500.

The examples given contain either one or two bladders, but the present invention also includes multiple bladder configurations, including various baffle and/or weld configurations to keep the bladder of more uniform thickness despite over- or under-filling. For example, separate bladders could be added to overlay either all or part of one or both leg regions for children, shorter adults, or subjects lacking one or both legs. Other embodiments feature bladders in each of the leg positions so that a subject lying on her side could have both leg bladders inflated with secondary bladder 442 deflated.

### Heating Subsystem

Many public buildings in the United States maintain their ambient air temperature within a few degrees of 72° F. Public swimming pools are often maintained at 78° F. for competitive swimming, but young children and older adults find 78° F. to be too cold, so many pools maintain 80-82° F. for recreational users. Dry hydrotherapy systems are designed to the pressurized liquid is not “cold,” so most typically maintain their pressurized liquid temperature between 90° F. and 105° F. In dry hydrotherapy systems use, the ambient air temperature is usually about 20° F. cooler than the preferred liquid temperature. When the dry hydrotherapy system is not in use, the liquid's temperature reverts to ambient air temperature and is often heated before use. Many systems use an in-tub, electric resistance heating element, but such elements suffer from calcification which decreases energy efficiency, increases energy costs, and decreases the element's useful life. Further, depending on design, an in-tub heater may be difficult to maintain. The design could require one to empty the tub and remove the flexible covers to gain access to the heating element. Obviously, with an empty tub, the dry hydrotherapy system is not available for use.

The present invention is an external heating system that overcomes the limitations of the prior art. FIG. A-13 shows a close-up view of an example of the present invention, which features heating element housing 450, heating element 452, thermal limit switch 454, pump intake hose 456, pump 458, and pump discharge hose 460. FIG. A-14 shows an overall view of the external heating system: tub suction pipe 462 is connected to tub 38 at one end and pump inlet hose 456 on the other; external heating element housing 450 is mounted to the outside of tub 38; pump 458 is mounted on the dry hydrotherapy frame structure; and return line 464 is connected to pump discharge hose 460 on one end and discharges back into tub 38 on the other. Pump 458 is a low pressure, low flow pump powered by an electrical motor. Pump 458 draws liquid from tub 38 via suction pipe 462 and pulls it through heating element 452. Heating element 452 is, in one embodiment, an aluminum tube with an electric resistance heating element attached to the outside of the tube. An electric source powers the resistance heating element, which electrical source is disconnected by thermal limit switch 454 if the temperature reaches 250° F. Pump 458 continues to pull the heated liquid through intake hose 456 and discharges the heated liquid through discharge hose 460—connected to return line 464—back into tub 38. Heating element 452 is controlled by a temperature sensor measuring tub 38 liquid's temperature. The temperature sensor may be located in tub 38 or outside tub 38 at any position to reliably indicate tub 38 liquid's temperature. In other embodiments, the heating system is equipped with isolation valves on suction pipe 462 and return line 464, or other functionally equivalent locations, so that the external heating system can be isolated from tub 38. With the isolation valves closed, the small amount of liquid trapped between the valves can be drained and the heating system maintained without removing the bed covers, without draining the much larger volume of liquid in tub 38, and still permitting the system to be used even without the external heating system. Further, the external heating system avoids the problems associated with calcification on an embedded heating element. For these and other reasons, the external heating system is less costly to operate and maintain.

### Cover Sheet System

FIGS. A-1 and A-2 give perspective views of the cover sheet system; FIG. A-15 shows a closer view. The cover sheet system of the present invention solves the prior art's otherwise conflicting problems of (1) delivering maximum hydrotherapy forces to the user while also (2) providing user support and (3) aesthetically pleasing appearance, as well as (4) minimizing the noise around the bed 10. Bed 10 addresses the objects by simultaneously providing a baggy, readily replaceable dry hydrotherapy “sheet” that transfers all hydrotherapy forces to the user together with a relatively tight, smooth, wrinkle-free outer cover that is free of the surface irregularities that are visually evident in a baggy cover sheet. Bed 10 includes a firm, flat top surface 470 that has a central window where the bulk of the user is positioned. Outer cover 470 is preferably a more stiff fabric relative to nylon sheet 472. More particularly, outer cover 470 is preferably made of synthetic leather (or the like) to provide a nice look and feel around the patient, particularly in the perimeter areas where therapy is less critical.

In contracts, the central rectangular window 471 through cover 470 is spanned by a loose and baggy sheet 472. Sheet 472 can be velcroed or sewn to cover 470 on it near underside, the border of window 471. To minimize fabric edges or seams beneath the user, however, it is preferably an independent sheet beneath cover 470, that is just exposed in window 471. Irrespective of where it is connected, sheet 472 is preferably separable from cover 470. Massage window 471, circumscribed by top surface 470, is where the bulk of the human subject lies during the dry hydrotherapy session. Sheet 472 is a loose fitting nylon sheet used underneath the human subject and on top of flexible membrane 52. Because sheet 472 is baggy and loose, it allows the dry hydrotherapy forces to be transferred to the subject. If sheet 472 were taut, it would attenuate, diffuse, and relocate some of the hydrotherapy forces and reduce the therapy's effectiveness in that window. The cover sheet system of the present invention also allows users to readily replace sheet 472 for laundry and maintenance.

Pillow 474 serves at least two purposes: it makes the dry hydrotherapy device look more like a bed, and it provides a comfortable head or body rest for the user. Although other pillows may be added, pillow 474 preferably is covered with synthetic leather fabric like perimeter 470 and is filled with Tempurpedic memory foam.

### Twin Gear Drive System

FIGS. A-16, A-17, and A-18 show examples of a gear drive system of the present invention that controls the movement of water jet carriage assembly 60. FIG. A-16 shows the relation between track drive motor 125 and large twin gears. FIG. A-17 shows a different view of the twin gears. Carriage assembly 60 controls the position of the water jet or jets. Other systems control the position of the carriage assembly using an electric motor connected directly to the drive system for the carriage assembly. Because of their limited ability to accurately control the positioning of the carriage assembly, other systems typically divide the carriage travel into discreet positions of only two to twelve separate positions. The present invention, however, because of its much improved carriage position control, divides the carriage travel into 200 units to make up 200 separate “body zones” in which to direct the discharge of the pressurized liquid.

The increased number of body zones is achieved, in part, by interposing gears between the electric motor and the carriage assembly drive mechanism. FIG. A-18 shows one embodiment with twin gears 480 and 484. The finer granularity in carriage assembly 60 position control is enabled by a position encoding system that includes raised tabs 482 on gear 480's side surface and at least one sensor 486 to detect the position, movement, or position and movement of the tabs. Sensor 486 communicates with microprocessor 166 and is controlled by proprietary software. The carriage assembly control software (which in at least one embodiment executes on microprocessor 166) receives gear position information from sensor 486 and commands the direction of rotation and speed of track drive motor 125 to position carriage assembly 60. With accurate gear position information, the software can much more accurately determine the actual position of carriage assembly 60, which then enables the system to provide 200 separate body zones rather than the conventional 2-12 zones. Another benefit of the dual gear arrangement in the drive train between the motor and the carriage assembly is that the combined gears effectively create a sizable flywheel that makes faster and quicker carriage assembly movement possible. The carriage assembly travel time from end-to-end is less than 60 seconds, typically about 45 seconds, whereas the nozzle carriages in the prior art systems were considerably slower and, therefore, created therapy that was less dynamic than with the improvements of the present invention.

### Grounding System

Another feature of the present invention is a grounding system for discharging electrical energy from the human body. The present invention provides a grounding system that is functionally equivalent to systems used by athletes whose anecdotal reports praise the reduced inflammation and decreased recovery time after rigorous training or events that they attribute to a grounding system. The grounding system of the present invention includes an electrical ground attachment point affixed to the surface of the bed. The ground attachment point is connected to an electrical ground such as the device's electrical ground system, which is in turn connected to the ground circuit of the electrical supply, which is eventually connected to the earth. The ground attachment point may also use a separate, dedicated ground circuit that is not shared by any other electrical device, and is connected directly to an earth ground. In one embodiment, an electrically conductive, disposable strap is connected to the ground attachment point at one end and to the user's wrist or ankle at the other end. In another embodiment, electrically conductive sheets or mats are attached to the ground attachment point so that the user's electrical charge is discharged through the sheet or mat connected to the ground attachment point and into an electrical ground.

The figures and descriptions in this application depict specific examples to teach those skilled in the art how to make and use the best mode of the invention. These examples are not given to limit the scope of the invention, but rather to teach inventive principles. To concisely teach inventive principles, some conventional aspects of the invention have been simplified or omitted. Those skilled in the art will appreciate many of the configurations, combinations, subcombinations, and variations on these examples that fall within the scope of the invention. For example, certain features of the invention described in separate embodiments can also be implemented in combination in a single embodiment. Conversely, various features that are described in the context of a single embodiment can also be implemented in multiple embodiments—separately or in any suitable subcombination. The invention is not limited to the specific illustrative examples described herein, but by all embodiments and methods within the scope and spirit of the invention as in the current, amended, or added claims and their equivalents. In any case, all substantially equivalent systems, articles, and methods should be considered within the scope of the invention.

We claim:

1. A system for providing dry hydrotherapy to a human subject in a reclined position, the system comprising:
a. a liquid container having walls defining an interior and an opening an containing a liquid to establish a liquid level;
b. a cover positioned and secured to close said opening of said liquid container, said cover having an underside directed towards said interior of said liquid container and an outside surface directed outwards from said interior of said liquid container; and
c. a liquid jet source positioned within said liquid container and oriented to direct liquid at said underside of said cover;
d. said liquid jet source including a jet manifold having an inlet port and at least one discharge orifice above said liquid level so that said liquid passes through air;
e. a carriage for moving said jet manifold through said container wherein movement of said carriage in said container changes a location towards which said liquid is directed on said underside of said cover;
f. a liquid conduit for conveying liquid from a liquid supply line connected to a source of pressurized liquid to said inlet port, said liquid conduit including a flexible hose, with a stationary or fixed positioning of a flexible tube where one end of said flexible hose to said inlet port and a pivoting coupling connecting an opposite end of said flexible hose to said liquid supply line wherein the combination of said flexible hose and said first fixed mount position and second pivoting coupling allow said carriage to freely move in said container while maintaining fluid communication between said feed line and said jet manifold;
g. wherein said human subject reclines on said outside surface of said cover and said liquid directed from said orifice at said underside of said cover conveys therapeutic massaging force to said human subject.

2. The system of claim 1 further comprising a liquid heating unit external to said liquid container wherein said heating unit comprises:
a. a pump system in fluid communication with said liquid container;
b. a desired temperature; and
c. a thermal energy transfer system in thermal communication with said liquid that increases the thermal energy of said liquid to achieve said desired temperature.

3. The system of claim 1 wherein the discharge pressure of said pressurized liquid is variable and controllable by a means selected from the group consisting of a motorized pressure valve, a manual pressure valve, and a variable speed electronically controlled motor.

4. The system of claim 1 wherein said cover comprises:
a. a liquid permeable support layer, said support layer capable of independently supporting a weight of said human subject and being permeable to said liquid directed at said underside of said cover; and
b. a liquid impermeable flexible barrier layer, said barrier layer serving to prevent the passage of said liquid directed at said underside of said cover, through said cover, and thereby to prevent said liquid from contacting said human subject, said barrier layer further transferring the force of said liquid contacting said underside of said cover through to said human subject reclining, said barrier layer positioned between said support layer and said human subject reclining; and
c. wherein said support layer generally bears the weight of said human subject and said barrier layer prevents the passage of liquid through said cover but transmits therapeutic massaging forces through said cover to said human subject; and
d. said liquid impermeable layer comprises a sheet of waterproof material secured and sealed to a perimeter of said walls of said liquid container; and
e. said waterproof material also has an RF welded, human body shaped fluid containment sack affixed to said waterproof barrier and said sack is sealed to be watertight.

5. The system of claim 1 further comprising:
a. an external shell cover, said shell cover comprising a plurality of removable panels, said panels configured to cover said walls of said liquid container on an outside of said container; and
b. wherein each of said removable panels comprises a rigid core comprising a wood, plastic, cloth or composite material and having a first side directed outward from said liquid container and a second side directed inward towards said liquid container; and
c. wherein a variety of surface layers having different colors and textures may be easily implemented in the construction of said removable panels; and
d. wherein the shape of said end panels are interchangeable and have a distinct bed-like head and foot board designed to resemble a standard looking home or daybed.

6. The system of claim 1 further comprising a system wherein the pressure of said pressurized liquid is variable and controllable by a means selected from the group consisting of (1) a motorized pressure valve, (2) a manual pressure valve, and (3) a variable speed motor controlled by an electronic controller where said electronic controller increases or decreases the motor speed to produce a corresponding increase or decrease in the discharge pressure from a pump connected to said variable speed motor.

7. A method for reducing noise associated with a dry hydrotherapy bed comprising:
a. defining a generally rectangular shape circumscribing the outline of a human form;
b. forming a first bladder on the top surface of a flexible membrane wherein said first bladder:
(1) comprises a fill tube and connector; and
(2) extends across the plurality of said top surface of said membrane but excludes a shape corresponding to a human body; and
c. filling said first bladder with a fluid type and volume sufficient to attenuate the noise from pressurized liquid impinging on the underside of said flexible membrane.

8. A system for showing a smooth surface on a dry hydrotherapy bed comprising:
a. a smooth top surface forming a decorative frame surrounding the massage window; and
b. a loose-fitting sheet covering the top surface of a flexible membrane wherein said loose fitting sheet is attached to said decorative frame using a hook and loop attachment means.
